(19) United States
(12) Patent Application Publication
(10) Pub. No.: US 2026/0009933 A1
(43) Pub. Date: Jan. 8, 2026

(54) DIFFUSION PLATE, METHOD OF MANUFACTURING DIFFUSION PLATE, AND PROJECTION DEVICE

(71) Applicant: AGC Inc., Tokyo (JP)

(72) Inventors: Kensuke ONO, Tokyo (JP); Yohei NAGAO, Tokyo (JP)

(73) Assignee: AGC Inc., Tokyo (JP)

(21) Appl. No.: 19/283,738

(22) Filed: Jul. 29, 2025

Related U.S. Application Data
(63) Continuation of application No. PCT/JP2024/002017, filed on Jan. 24, 2024.

(30) Foreign Application Priority Data
Feb. 1, 2023 (JP) 2023-014159

(51) Int. Cl. G02B 5/02; G03B 21/20

(52) U.S. Cl. CPC G02B 5/0215; G02B 5/0268; G02B 5/0278; G03B 21/208

(57) ABSTRACT

A diffusion plate includes: a glass substrate having a first main surface and a second main surface opposite to the first main surface; and a lens array formed on the first main surface of the glass substrate, wherein, when the first main surface of the glass substrate is viewed in a plan view, the glass substrate and the lens array each have a donut shape, the lens array includes a plurality of lenses, and the first main surface of the glass substrate has an annular first flat surface having a width equal to or more than 1.0 mm between an inner periphery of the glass substrate and an inner periphery of the lens array, or has an annular second flat surface having a width equal to or more than 1.0 mm between an outer periphery of the glass substrate and an outer periphery of the lens array.

### CROSS-REFERENCE TO RELATED APPLICATIONS

This application is a continuation application of International Application No. PCT/JP2024/002017, filed on Jan. 24, 2024, which is incorporated herein by reference in its entirety. Further, this application claims priority from Japanese Patent Application No. 2023-014159, filed on Feb. 1, 2023, the disclosure of which is incorporated by reference herein in their entirety.

### BACKGROUND

### Technical Field

The present disclosure relates to a diffusion plate, a method of manufacturing the diffusion plate, and a projection device.

### Related Art

As a method of manufacturing the diffusion plate, for example, there is a method of sandblasting one surface of a glass substrate. WO 2014/104106 A and WO 2019/189225 A disclose a diffusion plate including a glass substrate, and a lens array is formed on at least one surface of the glass substrate. It is generally known that a diffusion plate on which a lens array is formed has better light distribution controllability than a diffusion plate processed by sandblasting. The lens array includes plural lenses. For forming the lens array, for example, at least one selected from wet etching, dry etching, cutting processing, and laser processing is used.

A diffusion plate in which the glass substrate and the lens array each have a donut shape, when a main surface of the glass substrate is viewed from the front (i.e., viewed in a plan view), is conceivable. A through hole is formed at the center of the glass substrate, and a rotary shaft is fitted into the through hole.

In a case in which the main surface of the glass substrate has a donut shape, if the lens array is formed over the entire surface of the main surface of the glass substrate, excessive stress concentration may occur on an inner circumference or an outer circumference of the glass substrate due to the presence of the lenses, and the glass substrate may be broken.

### SUMMARY

An aspect of the present disclosure provides a technique for improving strength of a diffusion plate.

An aspect of the present disclosure is a diffusion plate including: a glass substrate having a first main surface and a second main surface opposite to the first main surface; and a lens array formed on the first main surface of the glass substrate, wherein, when the first main surface of the glass substrate is viewed in a plan view, the glass substrate and the lens array each have a donut shape, the lens array includes plural lenses, and the first main surface of the glass substrate has an annular first flat surface having a width equal to or more than 1.0 mm between an inner periphery of the glass substrate and an inner periphery of the lens array, or has an annular second flat surface having a width equal to or more than 1.0 mm between an outer periphery of the glass substrate and an outer periphery of the lens array.

According to the aspect of the present disclosure, an annular flat surface having a width equal to or more than 1.0 mm is provided along an inner periphery or an outer periphery of a first main surface. As a result, excessive stress concentration may be suppressed, and strength of a diffusion plate may be improved.

### BRIEF DESCRIPTION OF DRAWINGS

FIG. 1 is a plan view of a diffusion plate according to an embodiment.

FIG. 2 is a cross-sectional view taken along line II-II of FIG. 1.

FIG. 3 is a plan view illustrating an example of an array of lenses constituting the lens array of FIG. 1.

FIG. 4 is a sectional view illustrating an example of a projection device including the diffusion plate in FIG. 1.

FIG. 5 is a flowchart illustrating a method of manufacturing a diffusion plate according to the embodiment.

FIG. 6 is a cross-sectional view illustrating an example of S101 in FIG. 5.

FIG. 7 is a cross-sectional view illustrating an example of S102 in FIG. 5.

FIG. 8 is a cross-sectional view illustrating an example of S103 in FIG. 5.

FIG. 9 is a cross-sectional view illustrating an example of S104 in FIG. 5.

FIG. 10 is a cross-sectional view illustrating an example of a method of measuring breaking strength of the diffusion plate.

FIG. 11 is a boxplot diagram illustrating measurement results of the breaking strength of the diffusion plate according to Examples 1 to 3.

### DETAILED DESCRIPTION

Hereinafter, modes for carrying out the present disclosure will be described with reference to the drawings. In the drawings, similar or corresponding components are denoted by the same reference numerals, and description thereof may be omitted. In the specification, “to” indicating a numerical range means that numerical values described before and after the numerical range are included as a lower limit value and an upper limit value.

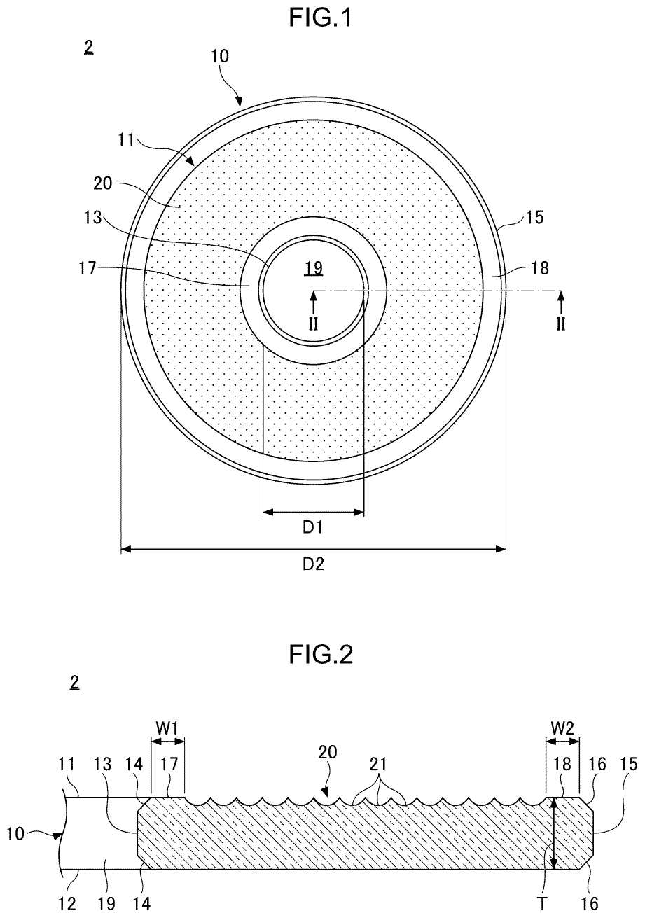

A diffusion plate 2 according to an embodiment will be described with reference to FIGS. 1 to 4. As illustrated in FIGS. 1 to 4, the diffusion plate 2 includes a glass substrate 10 and a lens array 20. The glass substrate 10 has a first main surface 11 and a second main surface 12 opposite to the first main surface 11. The lens array 20 is formed on the first main surface 11 of the glass substrate 10.

The lens array 20 is formed on the first main surface 11 of the glass substrate 10 and is not formed on the second main surface 12 of the glass substrate 10. The entire second main surface 12 of the glass substrate 10 is a flat surface. However, the lens array 20 may be formed not only on the first main surface 11 of the glass substrate 10 but also on the second main surface 12 of the glass substrate 10.

As illustrated in FIG. 1, the glass substrate 10 and the lens array 20 each have a donut shape when the first main surface 11 of the glass substrate 10 is viewed in plan view. In FIG. 1, a region of a dot pattern is a region of lens array 20. As illustrated in FIGS. 2 and 3, the lens array 20 includes plural lenses 21.

As illustrated in FIG. 2, the glass substrate 10 may have an inner peripheral surface 13 perpendicular to the first main surface 11 and the second main surface 12. The glass substrate 10 may also have a chamfered surface 14 at a boundary between the inner peripheral surface 13 and the first main surface 11 and at a boundary between the inner peripheral surface 13 and the second main surface 12. The chamfered surface 14 is a chamfered (C) surface in the present embodiment, but may be a round chamfered (R-chamfered) surface.

The glass substrate 10 may have an outer peripheral surface 15 perpendicular to the first main surface 11 and the second main surface 12. The glass substrate 10 may have a chamfered surface 16 at a boundary between the outer peripheral surface 15 and the first main surface 11 and at a boundary between the outer peripheral surface 15 and the second main surface 12. The chamfered surface 16 is a chamfered (C) surface in the present embodiment, but may be a round chamfered surface.

An inner diameter D1 (see FIG. 1) of the glass substrate 10 is preferably 5 mm to 20 mm, and more preferably 7 mm to 15 mm.

An outer diameter D2 (see FIG. 1) of the glass substrate 10 is preferably 20 mm to 100 mm, and more preferably 25 mm to 60 mm.

A plate thickness T (see FIG. 2) of the glass substrate 10 is preferably 0.2 mm to 2.0 mm, and more preferably 0.5 mm to 1.0 mm.

The first main surface 11 of the glass substrate 10 has an annular first flat surface 17 along an inner periphery of the glass substrate 10, or has an annular second flat surface 18 along the outer periphery of the glass substrate 10. In the present embodiment, the first main surface 11 has both the first flat surface 17 and the second flat surface 18, but the embodiment is not limited to this and the first main surface 11 may have only one of them.

As illustrated in FIG. 1, the first flat surface 17 is formed between the inner periphery of the glass substrate 10 and an inner periphery of the lens array 20. The inner periphery of the lens array 20 is provided concentrically with the inner periphery of the glass substrate 10 on the outer side of the inner periphery of the glass substrate 10. The inner periphery of the lens array 20 is the smallest virtual circle in contact with the plural lenses 21.

A width W1 (see FIG. 2) of the first flat surface 17 is, for example, equal to or more than 1.0 mm. When the width W1 is equal to or more than 1.0 mm, the distance between the inner periphery of the glass substrate 10 and the lens 21 is sufficiently distal, and it is possible to suppress occurrence of excessive stress concentration on the inner periphery of the glass substrate 10 due to the presence of the lens 21. It is possible to suppress a crack from extending from the inner periphery of the glass substrate 10, and the glass substrate 10 may be suppressed from being broken.

The width W1 of the first flat surface 17 is preferably equal to or more than 2.5 mm. As the width W1 is larger, the strength of the glass substrate 10 can be improved. However, the width W1 is preferably equal to or less than 30 mm from the viewpoint of downsizing the diffusion plate 2.

As illustrated in FIG. 1, the second flat surface 18 is formed between the outer periphery of the glass substrate 10 and the outer periphery of the lens array 20. The outer periphery of the lens array 20 is provided inside the outer periphery of the glass substrate 10 concentrically with the outer periphery of the glass substrate 10. The outer periphery of the lens array 20 is the largest virtual circle in contact with the plural lenses 21.

The width W2 (see FIG. 2) of the second flat surface 18 is, for example, equal to or more than 1.0 mm. When the width W2 is equal to or more than 1.0 mm, the distance between the outer periphery of the glass substrate 10 and the lens 21 is sufficiently distal, and occurrence of excessive stress concentration on the outer periphery of the glass substrate 10 due to the presence of the lenses 21 may be suppressed. It is possible to suppress a crack from extending from the outer periphery of the glass substrate 10, and the glass substrate 10 may be suppressed from being broken.

The width W2 of the second flat surface 18 is preferably equal to or more than 2.5 mm. The larger the width W2, the more the glass substrate 10 may be improved. However, the width W2 is preferably equal to or less than 10 mm from the viewpoint of downsizing the diffusion plate 2.

The material of the glass substrate 10 is not particularly limited, and may be, for example, aluminosilicate glass, borosilicate glass, or quartz glass.

As illustrated in FIGS. 2 and 3, the lens array 20 includes plural lenses 21. The lens 21 is a concave lens in the present embodiment, but may be a convex lens. The lens 21 is a spherical lens in the present embodiment, but may be an aspherical lens. The lens array 20 refracts and diffuses the light transmitted through the diffusion plate 2.

The plural lenses 21 have substantially the same shape and substantially the same dimension, and are regularly arranged. For example, as illustrated in FIG. 3, when the first main surface 11 of the glass substrate 10 is viewed in plan view, the center of the lens 21 is disposed at a lattice point of a regular hexagonal lattice (six vertices and one center of the regular hexagon). In FIG. 3, the gray scale represents the height difference. The closer the color of the image is from white to black, the lower the height is. In FIG. 3, a broken line represents a straight line connecting two adjacent vertexes of a regular hexagon.

The arrangement of the lenses 21 is not limited to the arrangement illustrated in FIG. 3. For example, the centers of the lenses 21 may be arranged at lattice points of a square lattice (four vertexes of a square) instead of the regular hexagonal lattice. The centers of the lenses 21 may be arranged at lattice points of a regular hexagonal lattice or a lattice obtained by compressing a square lattice in a predetermined direction. Further, the arrangement of lenses 21 need not be regular and may be irregular. The height difference of the lenses 21 may be the same or may be different among the plural lenses 21.

Each lens 21 has a hexagonal shape when the first main surface 11 of the glass substrate 10 is viewed in plan view. In this case, the equivalent circle diameter of each lens 21 is preferably 30 μm to 500 μm, and more preferably 110 μm to 300 μm. The height difference between the peripheral edge and the center of each lens 21 is preferably 3 μm to 50 μm. The shape of the lens 21 is a hexagon in the present embodiment, but the shape of the lens 21 is not limited to a hexagon, and may be, for example, a circle, an ellipse, or a polygon. There is no plane between the adjacent lenses 21 in the present embodiment, but the embodiment is not limited to this and, in another configuration, there may be a plane.

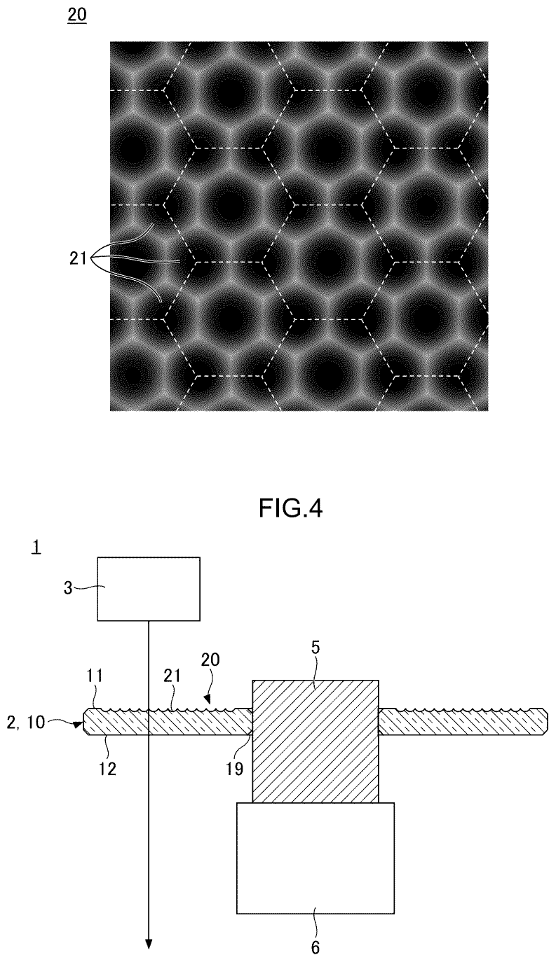

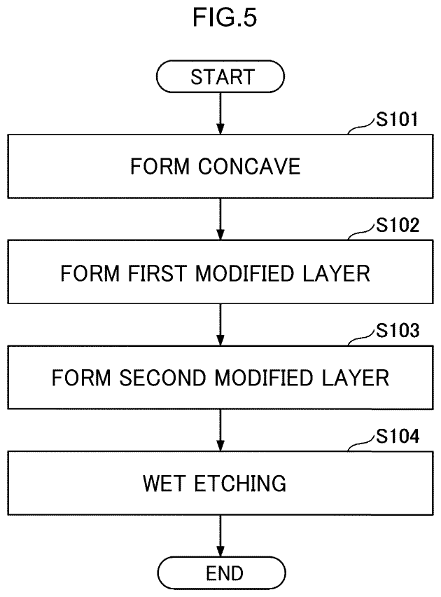

As illustrated in FIG. 4, the diffusion plate 2 is mounted on a projection apparatus (projector) 1, for example. The projection apparatus 1 is not particularly limited, and may be, for example, a head up display (HUD). The diffusion plate 2 transmits light emitted from light source 3. The transmitted light is diffused by the lens array 20. As a result, glare (speckle) of light may be suppressed.

The projection apparatus 1 includes, for example, the diffusion plate 2 and the light source 3. The light source 3 includes, for example, a laser light source. The laser light source is excellent in luminance and color rendering properties, but emphasizes glare. When the light source 3 includes a laser light source, an effect of suppressing glare by diffusion plate 2 is remarkably obtained. The light source 3 may include plural types of laser light sources, for example, a blue laser light source, a green laser light source, and a red laser light source.

The projection device 1 includes a rotary shaft 5 and a rotary motor 6. The rotary shaft 5 is fitted into a through hole 19 at the center of the glass substrate 10. The rotary motor 6 rotates the diffusion plate 2 together with the rotary shaft 5. The light emitted from the light source 3 passes through the diffusion plate 2 at a predetermined distance from a rotation center line of the rotary shaft 5. Even if lenses 21 are regularly arranged, glare of light may be suppressed by rotating the diffusion plate 2 together with the rotary shaft 5.

When the entire second main surface 12 of the glass substrate 10 is flat, the first main surface 11 of the glass substrate 10 is preferably disposed toward the light source 3. The unevenness of the lens array 20 may suppress reflection of light incident on the diffusion plate 2 from the light source 3. The light reflectance may be thereby reduced, and the light transmittance may be improved.

A method of manufacturing the diffusion plate 2 according to the embodiment will be described with reference to FIGS. 5 to 9. As illustrated in FIG. 5, the method of manufacturing diffusion plate 2 includes, for example, steps S101 to S104. The method of manufacturing the diffusion plate 2 may also include steps other than steps S101 to S104. For example, after step S104, a step of chamfering the inner periphery and the outer periphery of the glass substrate 10, that is, a step of forming the chamfered surfaces 14 and 16 may be performed. Before step S104, a process of heating the entire glass substrate 10 may be performed in order to reduce the stress remaining on the glass substrate 10 by laser processing.

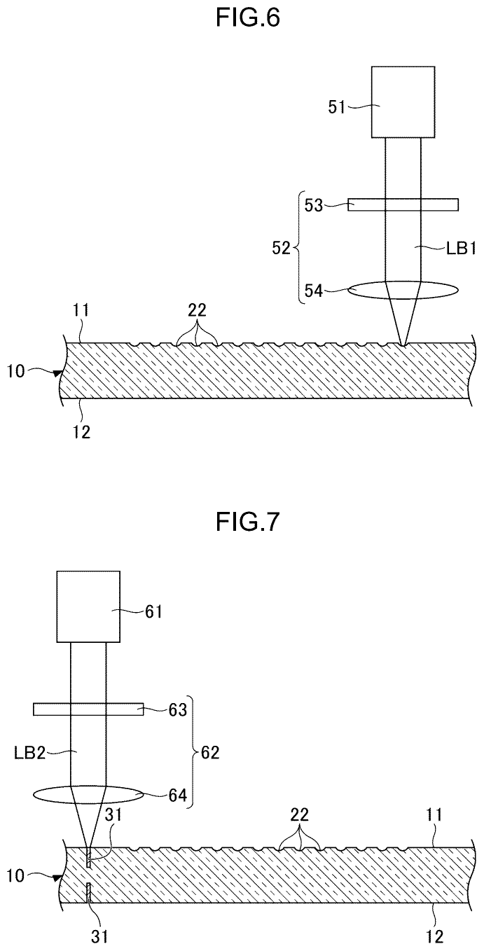

As illustrated in FIG. 6, step S101 includes forming a concave 22 by irradiating a position where each lens 21 is to be formed on the first main surface 11 of the glass substrate 10 with a first laser beam LB1. The concave 22 is formed at an irradiation position of the first laser beam LB1. In step S101, plural concaves 22 are formed by changing the irradiation position of the first laser beam LB1 on the first main surface 11 of the glass substrate 10. In the present embodiment, the irradiation position of the first laser beam LB1 is changed by movement of the glass substrate 10. Alternatively, the irradiation position may be changed by movement of an optical element (for example, a mirror) constituting an optical system 52.

The first laser beam LB1 forms the concave 22 by sublimating or evaporating glass. The shape and size of the concave 22 are controlled by a condensing position, a condensing angle, a condensing diameter, an irradiation time, and the like of the first laser beam LB1. Laser processing may suppress damage (for example, occurrence of latent scratches) of the glass substrate 10 and improve strength of the diffusion plate 2 as compared with blast processing. In the laser processing, it is easy to control the position where the concave 22 is formed and the shape and dimension of the concave 22 as compared with the blast processing.

As described above, the first laser beam LB1 forms the concave 22 by sublimating or evaporating glass. Therefore, the wavelength of the first laser beam LB1 is preferably 9.2 μm to 10.8 μm from the viewpoint of absorptivity by glass. A light source 51 of the first laser beam LB1 is preferably a CO₂ laser from the viewpoint of absorptivity by glass. The light source 51 is, for example, a continuous wave laser.

Immediately after the emission from the light source 51, polarized light of the first laser beam LB1 is linearly polarized light, and an intensity distribution of a cross section of the first laser beam LB1 is a Gaussian distribution. The optical system 52 is provided between the light source 51 and the glass substrate 10. The optical system 52 irradiates the glass substrate 10 with the first laser beam LB1 emitted from the light source 51. The first laser beam LB1 is perpendicularly incident on the first main surface 11 of the glass substrate 10. The optical system 52 includes, for example, a wave plate 53, a condenser lens 54, and the like.

The wave plate 53 converts the polarized light of the first laser beam LB1 from linearly polarized light into circularly polarized light. The wave plate 53 is formed of, for example, a ¼ wave plate. The wave plate 53 is disposed, for example, between the light source 51 and the condenser lens 54. In another configuration, the wave plate 53 may be omitted, and the optical system 52 may irradiate the glass substrate 10 with the linearly polarized first laser beam LB1.

The condenser lens 54 condenses and irradiates the glass substrate 10 with the first laser beam LB1. The condensing position of the first laser beam LB1 is, for example, the first main surface 11 of the glass substrate 10 or the vicinity thereof. The glass substrate 10 is locally heated, the heated portion is removed, and the concave 22 is formed. The condenser lens 54 is disposed, for example, between the wave plate 53 and the glass substrate 10.

The optical system 52 may include a homogenizer. The homogenizer converts the intensity distribution of the cross section of the first laser beam LB1 from the Gaussian distribution to a top-hat distribution. The homogenizer is disposed, for example, between the wave plate 53 and the condenser lens 54.

The optical system 52 may have an aperture. The aperture has a circular opening smaller than the cross section of the first laser beam LB1, and shields a peripheral edge of the cross section of the first laser beam LB1 to increase roundness of the cross section of the first laser beam LB1. The aperture is disposed, for example, between the wave plate 53 and the condenser lens 54. Alternatively, the aperture is disposed between the homogenizer and the condenser lens 54, for example.

Various functional films may be formed on the glass substrate 10 before step S101.

For example, a protective film may be formed on at least one of the first main surface 11 and the second main surface 12 of the glass substrate 10. The protective film prevents adhesion of processing waste scattering from the first main surface 11 by irradiation with the first laser beam LB1. The protective film is preferably a removable film, for example, a water-soluble film.

As illustrated in FIG. 7, step S102 includes forming a first modified layer 31 by irradiating the position where the inner periphery of the glass substrate 10 is to be formed with a second laser beam LB2. For example, the first modified layer 31 is linearly formed from the first main surface 11 to a predetermined depth, and is linearly formed from the second main surface 12 to a predetermined depth. Although not illustrated, the first modified layer 31 may be formed over the entire glass substrate 10 in a plate thickness direction.

Step S102 includes repeatedly rotating the glass substrate 10 and irradiating a position at a certain distance from the rotation center line of the glass substrate 10 with the second laser beam LB2. A distance between the optical axis of the second laser beam LB2 and the rotation center line of the glass substrate 10 is equal to a half value of inner diameter D1 of the glass substrate 10. In the present embodiment, the irradiation position of the second laser beam LB2 is changed by movement (more specifically, rotational movement) of the glass substrate 10. Alternatively, the irradiation position may be changed by movement of an optical element (for example, a mirror) constituting the optical system 62.

The second laser beam LB2 forms the first modified layer 31 by modifying glass. In the portion where the second laser beam LB2 is condensed, two-photon absorption occurs, interaction between the second laser beam LB2 and glass occurs, physical properties (for example, density) of the glass are modified, and the first modified layer 31 is formed. The shape and dimension of the first modified layer 31 are controlled by a condensing position, a condensing angle, a condensing diameter, an irradiation time, and the like of the second laser beam LB2.

As described above, the second laser beam LB2 forms the first modified layer 31 by modifying glass. Therefore, the wavelength of the second laser beam LB2 is preferably 1000 nm to 1100 nm. The light source 61 of the second laser beam LB2 is, for example, a YAG laser. The light source 61 may oscillate a second harmonic wave, a third harmonic wave, or the like. The light source 61 is, for example, a pulse oscillation laser. The pulse width (time width per pulse) is, for example, 100 fs (femtosecond) to 20 ps (picosecond).

An optical system 62 is provided between the light source 61 and the glass substrate 10. The optical system 62 irradiates the glass substrate 10 with the second laser beam LB2 emitted from the light source 61. The second laser beam LB2 is perpendicularly incident on the first main surface 11 or the second main surface 12 of the glass substrate 10. The optical system 62 includes, for example, a wave plate 63, a condenser lens 64, and the like. Since the optical system 62 is configured similarly to the optical system 52, the description thereof will be omitted.

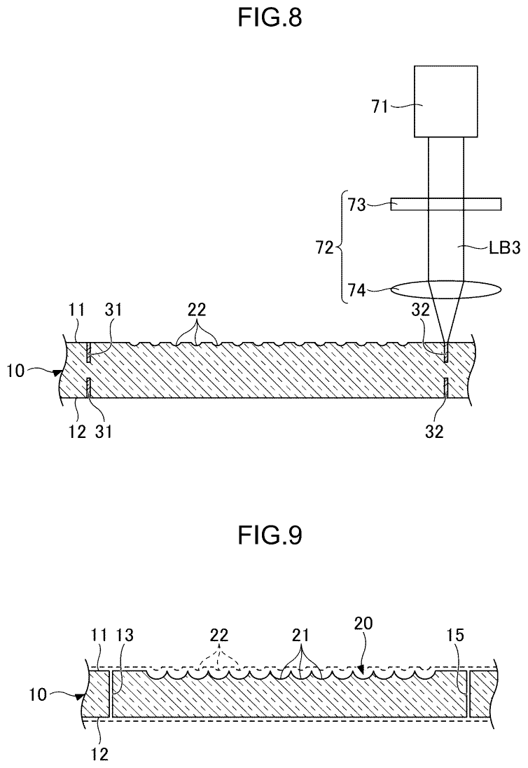

As illustrated in FIG. 8, step S103 includes forming a second modified layer 32 by irradiating a position where the outer periphery of the glass substrate 10 is to be formed with the third laser beam LB3. The second modified layer 32 is linearly formed, for example, from the first main surface 11 to a predetermined depth, and is linearly formed from the second main surface 12 to a predetermined depth. Although not illustrated, the second modified layer 32 may be formed over the entire glass substrate 10 in the plate thickness direction.

Step S103 repeatedly includes repeatedly rotating the glass substrate 10 and irradiating a position at a certain distance from the rotation center line of the glass substrate 10 with the third laser beam LB3. A distance between the optical axis of the third laser beam LB3 and the rotation center line of the glass substrate 10 is equal to a half value of the outer diameter D2 of the glass substrate 10. In the present embodiment, the irradiation position of the third laser beam LB3 is changed by movement (more specifically, rotational movement) of the glass substrate 10. Alternatively, the irradiation position may be changed by movement of an optical element (for example, a mirror) constituting an optical system 72.

Similarly to the second laser beam LB2, the third laser beam LB3 forms the second modified layer 32 by modifying glass. A light source 71 of the third laser beam LB3 is configured similarly to the light source 61 of the second laser beam LB2, and thus the description thereof is omitted.

The optical system 72 is provided between the light source 71 and the glass substrate 10. The optical system 72 irradiates the glass substrate 10 with the third laser beam LB3 emitted from the light source 71. The third laser beam LB3 is perpendicularly incident on the first main surface 11 or the second main surface 12 of the glass substrate 10. The optical system 72 includes, for example, a wave plate 73, a condenser lens 74, and the like. Since the optical system 72 is configured similarly to the optical system 52, the description thereof will be omitted.

The order of steps S101, S102, and S103 is not particularly limited. For example, after S102 and S103, S101 may be performed. In addition, S103 and S104 may be performed in parallel, and specifically, after the first modified layer 31 and the second modified layer 32 are formed on one surface of the glass substrate 10, the first modified layer 31 and the second modified layer 32 may be formed on the opposite surface of the glass substrate 10.

Step S104 includes wet-etching the glass substrate 10 on which the concave 22, the first modified layer 31, and the second modified layer 32 are formed to collectively form the lens array 20, the inner periphery of the glass substrate 10, and the outer periphery of the glass substrate 10 as illustrated in FIG. 9. The etching solution is selected according to the material of the glass substrate 10, and may be, for example, a mixed acid of hydrofluoric acid (HF) and hydrochloric acid (HCl). Step S104 includes, for example, immersing the glass substrate 10 in an etching solution.

The concave 22 is etched to form the lens 21. In this case, a concave lens is formed as the lens 21. The first modified layer 31 and the second modified layer 32 are more easily etched than before the modification, and are selectively etched. Wet etching may suppress damage (for example, occurrence of latent scratches) of the glass substrate 10 and improve strength of the diffusion plate 2 as compared with cutting.

### EXAMPLES

Experimental data will be described below. Among the following Examples 1 to 4, Examples 1 to 3 are examples, and Example 4 is a comparative example.

### Example 1

In Example 1, the diffusion plate 2 illustrated in FIGS. 1 to 3 was manufactured by the manufacturing method illustrated in FIG. 5. As the glass substrate 10, “Dragontrail® Pro” (aluminosilicate glass) manufactured by AGC Inc. was prepared. The thickness of the glass substrate 10 is 1.1 mm.

The conditions of step S101 in FIG. 5 were as follows.
Light source: CO₂ laser,
wavelength: 9.6 μm,
condensing angle: about 20°.

The concaves 22 were formed only on the first main surface 11 of the glass substrate 10, and were not formed on the second main surface 12 of the glass substrate 10. The concaves 22 were regularly arranged in a region where the lens array 20 is to be formed (shape: donut shape, inner diameter: 11 mm, outer diameter: 27 mm). Specifically, the concaves 22 were formed at lattice points of the regular hexagonal lattice. The concaves 22 each have a diameter of 70 μm, a depth of 120 μm, and an average pitch (distance between lens centers) of 270 μm. The conditions of steps S102 and S103 in FIG. 5 were as follows.
Light source: YAG laser,
wavelength: 1030 nm,
pulse width: 5 ps to 10 ps,
pulse energy: 50 μJ, and
magnification of condenser lens: 20 times.

The first modified layer 31 was formed so as to draw a circle having a diameter of 9 mm on each of the first main surface 11 and the second main surface 12 of the glass substrate 10. The second modified layer 32 was formed so as to draw a circle having a diameter of 30 mm on each of the first main surface 11 and the second main surface 12 of the glass substrate 10. The above circle having a diameter of 9 mm and the above circle having a diameter of 30 mm were arranged concentrically.

The conditions of step S104 in FIG. 5 were as follows.
Etching liquid: mixed acid of hydrofluoric acid and hydrochloric acid,
hydrofluoric acid concentration: 2 mol/L,
hydrochloric acid concentration: 4 mol/L.

Step S104 includes bringing both of the first main surface 11 and the second main surface 12 of the glass substrate 10 into contact with the etching solution (S104a), attaching an adhesive tape to the second main surface 12 of glass substrate 10 (S104b), and bringing only the first main surface 11 of the glass substrate 10 into contact with the etching solution (S104c) in this order.

The time of S104a was set so that the glass substrate 10 was not completely divided at the position where the first modified layer 31 and the second modified layer 32 were formed. In S104a, the etching amount of the first main surface 11 was 280 μm, and the etching amount of the second main surface 12 was 80 μm.

The time of S104c was set so that the glass substrate 10 was completely divided at the position where the first modified layer 31 and the second modified layer 32 were formed. In S104c, the etching amount of the first main surface 11 was 20 μm.

In Example 1, 25 diffusion plates 2 were manufactured by the above manufacturing method. The glass substrate 10 constituting each diffusion plate 2 had an inner diameter D1 of 9 mm, an outer diameter D2 of 30 mm, a width W1 of 1.0 mm, a width W2 of 1.5 mm, and a plate thickness T of about 0.7 mm (1.1 mm-280 μm-80 μm-20 μm).

### Example 2

In Example 2, 25 diffusion plates 2 were manufactured under the same conditions as in Example 1 except that the inner diameter of the region where the lens array 20 is to be formed was changed from 11 mm to 14 mm in S101. The glass substrate 10 constituting each diffusion plate 2 had an inner diameter D1 of 9 mm, an outer diameter D2 of 30 mm, a width W1 of 2.5 mm, a width W2 of 1.5 mm, and a plate thickness T of about 0.7 mm.

### Example 3

In Example 3, 20 diffusion plates 2 were manufactured under the same conditions as in Example 1 except that the inner diameter of the region where the lens array 20 is to be formed was changed from 11 mm to 18 mm in S101. The glass substrate 10 constituting each diffusion plate 2 had an inner diameter D1 of 9 mm, an outer diameter D2 of 30 mm, a width W1 of 4.5 mm, a width W2 of 1.5 mm, and a plate thickness T of about 0.7 mm.

### Example 4

In Example 4, 19 diffusion plates 2 were manufactured under the same conditions as in Example 1 except that the concave 22 was formed in a circular region (diameter: 32 mm) in S101, S104 was performed without performing S102 and S103 after S101, and the glass substrate 10 was cut into a donut shape by cutting after step S104. The glass substrate 10 constituting each diffusion plate 2 had an inner diameter D1 of 9 mm, an outer diameter D2 of 30 mm, a width W1 of 0.0 mm, a width W2 of 0.0 mm, and a plate thickness T of about 0.7 mm.

### Evaluation

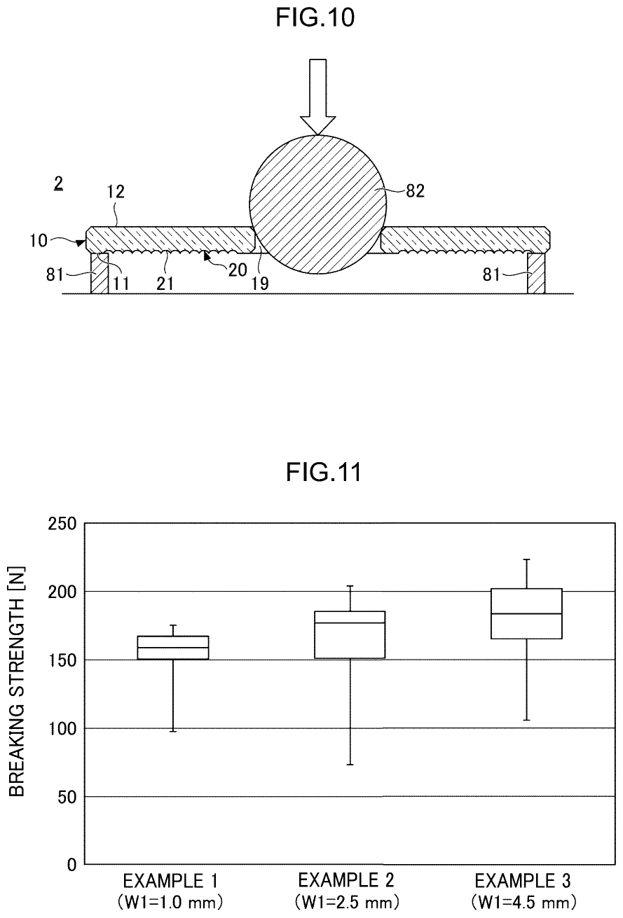

The strength of the diffusion plate 2 was measured by a ball-on-ring method. Specifically, as illustrated in FIG. 10, the glass substrate 10 was placed on a ring 81 with the first main surface 11 facing downward so that the maximum tensile stress was generated on an inner periphery of the first main surface 11 of the glass substrate 10, and a ball 82 inserted into the through hole 19 of the glass substrate 10 from above was pressed downward to measure the breaking load (N) of the glass substrate 10. The inner diameter of the ring 81 was 25 mm, and the diameter of the ball 82 was 10 mm.

FIG. 11 and Table 1 illustrate measurement results of breaking strength of the diffusion plate 2 according to Examples 1 to 3. Table 1 also illustrates measurement results of the breaking strength of the diffusion plate 2 according to Example 4.

TABLE 1

| | | | | | | Central value |
|---|---|---|---|---|---|---|
| | D1 | D2 | W1 | W2 | Number of | of breaking |
| | [mm] | [mm] | [mm] | [mm] | plates | load |
| Example 4 | 9 | 30 | 0.0 | 0.0 | 19 | 44 |
| Example 1 | 9 | 30 | 1.0 | 1.5 | 25 | 158 |
| Example 2 | 9 | 30 | 2.5 | 1.5 | 25 | 177 |
| Example 3 | 9 | 30 | 4.5 | 1.5 | 20 | 183 |

FIG. 11 and Table 1 (mainly Table 1) illustrate that the strength of diffusion plate 2 may be improved by providing the annular first flat surface 17 having a width equal to or more than 1.0 mm along the inner periphery of the first main surface 11.

The following supplementary notes regarding the above embodiments and the like are disclosed.

### [Supplementary Note 1]

A diffusion plate including:
a glass substrate having a first main surface and a second main surface opposite to the first main surface; and
a lens array formed on the first main surface of the glass substrate,
wherein, when the first main surface of the glass substrate is viewed in plan view, the glass substrate and the lens array each have a donut shape, the lens array includes plural lenses, and
the first main surface of the glass substrate has an annular first flat surface having a width equal to or more than 1.0 mm between an inner periphery of the glass substrate and an inner periphery of the lens array, or has an annular second flat surface having a width equal to or more than 1.0 mm between an outer periphery of the glass substrate and an outer periphery of the lens array.

### [Supplementary Note 2]

The diffusion plate according to Supplementary note 1, wherein the first main surface of the glass substrate has an annular first flat surface having a width equal to or more than 2.5 mm between the inner periphery of the glass substrate and the inner periphery of the lens array, or has an annular second flat surface having a width equal to or more than 2.5 mm between the outer periphery of the glass substrate and the outer periphery of the lens array.

### [Supplementary Note 3]

The diffusion plate according to Supplementary note 1 or 2, wherein the glass substrate has a plate thickness of 0.2 mm to 2.0 mm.

### [Supplementary Note 4]

The diffusion plate according to Supplementary note 3, wherein the glass substrate has a thickness of 0.5 mm to 1.0 mm.

### [Supplementary Note 5]

A method of manufacturing the diffusion plate according to any one of Supplementary notes 1 to 4, the method including:
forming a concave by irradiating a position where each of the lenses is to be formed on the first main surface of the glass substrate with a first laser beam;
forming a first modified layer by irradiating a position where the inner periphery of the glass substrate is to be formed with a second laser beam;
forming a second modified layer by irradiating a position where the outer periphery of the glass substrate is to be formed with a third laser beam; and
collectively forming the lens array, the inner periphery of the glass substrate, and the outer periphery of the glass substrate by wet-etching the glass substrate on which the concave, the first modified layer, and the second modified layer are formed.

### [Supplementary Note 6]

The method of manufacturing the diffusion plate according to Supplementary note 5, wherein
a wavelength of the first laser beam is 9.2 μm to 10.8 μm, a wavelength of the second laser beam is 1000 nm to 1100 nm, and a wavelength of the third laser beam is 1000 nm to 1100 nm.

### [Supplementary Note 7]

A projection device including:
the diffusion plate according to any one of Supplementary notes 1 to 4;
a rotary shaft fitted into a through hole at a center of the glass substrate;
a rotation motor that rotates the diffusion plate together with the rotary shaft; and
a light source that irradiates the diffusion plate with light diffused by the lens array at a predetermined distance from a rotation center line of the rotary shaft.

Although the diffusion plate, the diffusion plate, and the method of manufacturing the projection device according to the present disclosure have been described above, the present disclosure is not limited to the above embodiments and the like. Various changes, modifications, substitutions, additions, deletions, and combinations are possible within the scope described in the claims. They also naturally belong to the technical scope of the present disclosure.

What is claimed is:

1. A diffusion plate comprising:
a glass substrate having a first main surface and a second main surface opposite to the first main surface; and
a lens array formed on the first main surface of the glass substrate,
wherein, when the first main surface of the glass substrate is viewed in a plan view, the glass substrate and the lens array each have a donut shape, the lens array includes a plurality of lenses, and
the first main surface of the glass substrate has an annular first flat surface having a width equal to or more than 1.0 mm between an inner periphery of the glass substrate and an inner periphery of the lens array, or has an annular second flat surface having a width equal to or more than 1.0 mm between an outer periphery of the glass substrate and an outer periphery of the lens array.

2. The diffusion plate according to claim 1, wherein the first main surface of the glass substrate has an annular first flat surface having a width equal to or more than 2.5 mm between the inner periphery of the glass substrate and the inner periphery of the lens array, or has an annular second flat surface having a width equal to or more than 2.5 mm between the outer periphery of the glass substrate and the outer periphery of the lens array.

3. The diffusion plate according to claim 1, wherein the glass substrate has a plate thickness of 0.2 mm to 2.0 mm.

4. The diffusion plate according to claim 3, wherein the glass substrate has a thickness of 0.5 mm to 1.0 mm.

5. A method of manufacturing the diffusion plate according to claim 1, the method comprising:
forming a concave by irradiating a position where each of the lenses is to be formed on the first main surface of the glass substrate with a first laser beam;
forming a first modified layer by irradiating a position where the inner periphery of the glass substrate is to be formed with a second laser beam;
forming a second modified layer by irradiating a position where the outer periphery of the glass substrate is to be formed with a third laser beam; and
collectively forming the lens array, the inner periphery of the glass substrate, and the outer periphery of the glass substrate by wet-etching the glass substrate on which the concave, the first modified layer, and the second modified layer are formed.

6. The method of manufacturing the diffusion plate according to claim 5, wherein a wavelength of the first laser beam is 9.2 μm to 10.8 μm, a wavelength of the second laser beam is 1000 nm to 1100 nm, and a wavelength of the third laser beam is 1000 nm to 1100 nm.

7. A projection device comprising:
the diffusion plate according to claim 1;
a rotary shaft fitted into a through hole at a center of the glass substrate;
a rotation motor that rotates the diffusion plate together with the rotary shaft; and
a light source that irradiates the diffusion plate with light diffused by the lens array at a predetermined distance from a rotation center line of the rotary shaft.
